(19) United States
(12) Patent Application Publication
(10) Pub. No.: US 2026/0043389 A1
(43) Pub. Date: Feb. 12, 2026

(54) HEAT EXCHANGER COUPLING WITH ELECTROCHEMICAL HYDROGEN PUMPS USING FORCED CONVECTION OPERATION

(71) Applicant: JTEC ENERGY, INC., Atlanta, GA (US)

(72) Inventors: Abhijeet MANIKTALA, Atlanta, GA (US); Christopher Smith, Sandy Springs, GA (US)

(21) Appl. No.: 19/293,743

(22) Filed: Aug. 7, 2025

Related U.S. Application Data
(60) Provisional application No. 63/680,923, filed on Aug. 8, 2024.

(51) Int. Cl. F03G 7/00; F04B 45/053; F04C 18/00; F04D 17/08

(52) U.S. Cl. CPC F03G 7/0254; F04B 45/053; F04C 18/00; F04D 17/08

(57) ABSTRACT

A thermo-electrochemical converter includes a working fluid, and first and second membrane electrode assemblies (MEAs). A first chamber is in fluid communication with the first electrode of the first MEA. A second chamber is in fluid communication with the second electrode of the first MEA. A third chamber is in fluid communication with the first electrode of the second MEA. A fourth chamber is in fluid communication with the second electrode of the second MEA. First and second conduits are in fluid communication with the first and third chambers. A fluid handler moves the working fluid from the third chamber to the first chamber through the first conduit. A heat exchanger is in thermal communication with the first and second conduits and is configured to transfer heat from the working fluid in the first conduit to the working fluid in the second conduit.

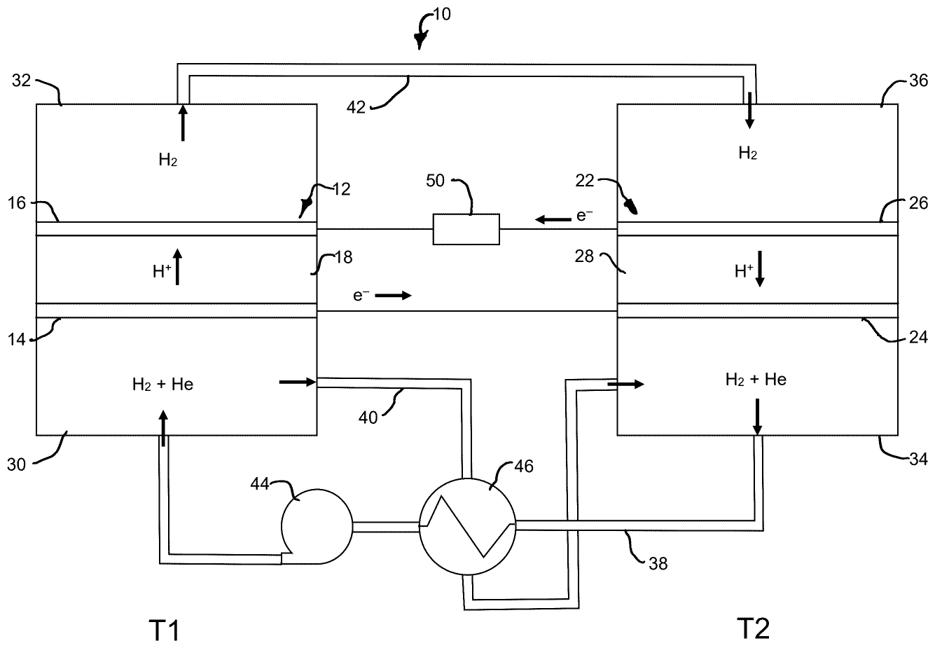

### CROSS-REFERENCE TO RELATED APPLICATIONS

This application claims the benefit of U.S. Provisional Patent Application No. 63/680,923, filed Aug. 8, 2024, entitled “Heat exchanger coupling with Electrochemical Hydrogen Pumps using Forced Convection Operation,” currently pending, the entire contents of which are incorporated by reference herein.

### BACKGROUND

Embodiments described herein relate generally to thermo-electrochemical cells, and more particularly, to operating a thermo-electrochemical cell with increased performance and efficiency through increased pressure ratios while maximizing temperature differential.

Electric potentials in hydrogen pumps or similar devices, such as the Johnson Thermo-electrochemical Converter (JTEC) or the like, are determined by the Nernst equation:

$$V = \frac{RT}{2 F} ln \frac{{P}_{H}}{{P}_{L}} ,$$

where V is a total voltage from a single cell JTEC, R is the gas constant, T is a temperature difference between hot and cold sides, F is Faraday's constant, and P_{H} and P_{L} are high- and low-pressure hydrogen concentrations. Increasing hydrogen pressure ratios across a membrane electrode assembly in said hydrogen pumps increases the power density that can be generated by the pump. However, increased fluid flow rates in the low pressure chamber of such devices results in convective heat losses. The heat losses are associated with voltage decay, and eventually the cell is polarized under operation and fails to generate power.

Prior solutions to this issue included increasing the cold side temperature and modifying fluid flow fields to improve the natural convection of the fluids inside a stack. The cold side temperature increase resulted in loss of performance due to the decreased overall cell voltage. Fluid flow modification only provides marginal improvements to voltage decay.

It is desirable to provide a thermo-electrochemical converter that can improve on performance and efficiency through an increase in the pressure ratio while also reducing or eliminating the resultant temperature differential drops attributable to convective heat losses.

### BRIEF SUMMARY

Briefly stated, one embodiment comprises a thermo-electrochemical converter including an ionizable working fluid, and a first membrane electrode assembly (MEA) and a second MEA electrically coupled to each other. Each of the first and second MEAs includes a first electrode permeable to the ionizable working fluid, a second electrode permeable to the ionizable working fluid, and a proton-exchange membrane sandwiched between the first and second electrodes. A first chamber is in fluid communication with the first electrode of the first MEA and contains the ionizable working fluid at a first pressure. A second chamber is in fluid communication with the second electrode of the first MEA and contains the ionizable working fluid at a second pressure greater than the first pressure. The first MEA, first chamber, and second chamber operate at a first temperature. A third chamber is in fluid communication with the first electrode of the second MEA and contains the ionizable working fluid at a third pressure. A fourth chamber is in fluid communication with the second electrode of the second MEA and contains the ionizable working fluid at a fourth pressure greater than the third pressure. The second MEA, third chamber, and fourth chamber operate at a second temperature greater than the first temperature. A first conduit and a second conduit are each in fluid communication with the first chamber and the third chamber. A third conduit is in fluid communication with the second chamber and the fourth chamber. A fluid handler is configured to move the ionizable working fluid from the third chamber to the first chamber through the first conduit. A heat exchanger is in thermal communication with the first and second conduits and is configured to transfer heat from the ionizable working fluid in the first conduit to the ionizable working fluid in the second conduit.

In one aspect, the ionizable working fluid is mixed with an inert carrier fluid in the first and third chambers. In a further aspect, the working fluid is H₂ gas and the inert carrier fluid is He gas.

In another aspect, the fluid handler is a pump. In a further aspect, the pump is one of a diaphragm pump or a rotary vane pump.

In yet another aspect, the fluid handler is a blower. In a further aspect, the blower is a centrifugal blower.

In still another aspect, the heat exchanger is one of a shell-and-tube heat exchanger, a plate heat exchanger, a finned tube heat exchanger, or a shell-and-coil heat exchanger.

In yet another aspect, the working fluid is H₂ gas.

Another embodiment comprises a method of operating a thermo-electrochemical converter including an ionizable working fluid, and a first membrane electrode assembly (MEA) and a second MEA electrically coupled to each other. Each of the first and second MEAs includes a first electrode permeable to the ionizable working fluid, a second electrode permeable to the ionizable working fluid, and a proton-exchange membrane sandwiched between the first and second electrodes. The method includes operating, at a first temperature, the first MEA, a first chamber in fluid communication with the first electrode of the first MEA and containing the ionizable working fluid at a first pressure, and a second chamber in fluid communication with the second electrode of the first MEA and containing the ionizable working fluid at a second pressure greater than the first pressure, operating, at a second temperature greater than the first temperature, the second MEA, a third chamber in fluid communication with the first electrode of the second MEA and containing the ionizable working fluid at a third pressure, and a fourth chamber in fluid communication with the second electrode of the second MEA and containing the ionizable working fluid at a fourth pressure greater than the third pressure, providing a first conduit and a second conduit, each in fluid communication with the first chamber and the third chamber, providing a third conduit in fluid communication with the second chamber and the fourth chamber, moving, via a fluid handler, the ionizable working fluid from the third chamber to the first chamber through the first conduit, and transferring heat from the ionizable working fluid in the first conduit to the ionizable working fluid in the second conduit via a heat exchanger in thermal communication with the first and second conduits.

In one aspect, the method further includes providing the ionizable working fluid within an inert carrier fluid in the first and third chambers. In a further aspect, the working fluid is H₂ gas and the inert carrier fluid is He gas.

In another aspect, the working fluid is H₂ gas.

### BRIEF DESCRIPTION OF THE SEVERAL VIEWS OF THE DRAWINGS

The following detailed description of preferred embodiments will be better understood when read in conjunction with the appended drawings. For the purpose of illustration, there are shown in the drawings embodiments which are presently preferred. It should be understood, however, that the invention is not limited to the precise arrangements and instrumentalities shown.

The accompanying FIGURE is a schematic block diagram of a thermo-electrochemical converter in accordance with an example embodiment.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

There is shown in the accompanying FIGURE a thermo-electrochemical converter 10 in accordance with an example embodiment. The thermo-electrochemical converter 10 may be a JTEC, a hydrogen pump, or the like for converting heat or chemical energy into electrical energy or vice-versa. The thermo-electrochemical converter 10 may operate on an ionizable working fluid that may be expanded and compressed as it traverses the thermo-electrochemical converter during operation. The ionizable working fluid may be hydrogen (H₂) gas, although other types of working fluids may be used as well, such as ammonia, methanol, hydrazine, or the like.

The thermo-electrochemical converter 10 may include a first membrane electrode assembly (MEA) 12 and a second MEA 22. The first MEA 12 includes a first electrode 14 permeable to the ionizable working fluid, a second electrode 16 permeable to the ionizable working fluid, and a proton-exchange membrane 18 sandwiched between the first and second electrodes 14, 16. The second MEA 22 has a similar construction with a first electrode 24, a second electrode 26, and a proton-exchange membrane 28 sandwiched between the two.

The first electrodes 14, 24 and second electrodes 16, 26 may be made from suitable materials, such as carbon, ceramic, metal, metalorganic, combinations thereof, or the like and each have a thickness typically ranging from about 10 to about 300 micrometers. The proton-exchange membranes 18, 28 may be made from polymeric material, ceramic material, combinations thereof, or the like, and may each have a thickness typically ranging from about 10 to about 300 micrometers.

The first and second MEAs 12, 22 may be electrically coupled to each other across an external load 50. In operation, electrons are stripped from the working fluid at the interfaces of the first electrode 14 of the first MEA 12 and the second electrode 26 of the second MEA 22. The resulting ions (e.g., protons (H⁺) or other ions) are conducted through the respective proton-exchange membranes 18, 28 in the directions indicated by arrows in the FIGURE. Electrons flow in the circuit including the load 50 and are supplied to the second electrode 16 of the first MEA 12 and the first electrode 24 of the second MEA 22 and recombine with the conducted ions to reconstitute the working fluid.

A first chamber 30 may be provided in fluid communication with the first electrode 14 of the first MEA 12. The first chamber 30 may contain the ionizable working fluid at a first pressure, which may be between about 0.1 and about 2 bar (absolute), although other pressure values for the first chamber 30 may be used, as desired. A second chamber 32 may be provided in fluid communication with the second electrode 16 of the first MEA 12. The second chamber 32 may contain the ionizable working fluid at a second pressure that is greater than the first pressure. The second pressure may be between about 1 and about 50 bar (absolute), although other pressure values may be used for the second chamber 32, as desired. A ratio of the second pressure to the first pressure is preferably between about 2:1 and about 25:1, more preferably at about 20:1, although other pressure ratios may be utilized depending on the configurations and needs of the system.

The second MEA 22 is similarly situated between third and fourth chambers 34, 36. The third chamber 34 may be provided in fluid communication with the first electrode 24 of the second MEA 22 and contain the ionizable working fluid at a third pressure, which may be similar or identical to the first pressure described above, since, as detailed further below, the first and third chambers 30, 34 are in fluid communication with one another. The fourth chamber 36 may be provided in fluid communication with the second electrode 26 of the second MEA 22 and contain the ionizable working fluid at a fourth pressure that is greater than the third pressure. The second and fourth chambers 32, 36 may be in fluid communication with one another, as described in more detail below, so the fourth pressure may be similar or identical to the second pressure.

The first MEA 12, first chamber 30, and second chamber 32 may operate as the “cold” side of the thermo-electrochemical converter 10 at a first temperature T1, while the second MEA 22, third chamber 34, and fourth chamber 36 may operate as the “hot” side at a second temperature T2 that is greater than the first temperature T1. The first temperature T1 may be between about 20° C. and about 50° C., although other values for the first temperature T1 may be used as well. The second temperature T2 may be between about 60° C. and about 180° C., although other values for the second temperature T2 may be used as well. A typical ratio of T2/T1 may be about 5:1, although other temperature ratios may be utilized depending on the configurations and needs of the system. To provide the temperature differential, the “hot” side of the thermo-electrochemical converter 10 may be exposed to an external heat source (not shown), which may directly or indirectly supply heat to one or more the second MEA 22, third chamber 34, and/or fourth chamber 36. Additionally or alternatively, the “cold” side may be in thermal communication with an external heat sink (not shown). In still other embodiments, the “cold” side may be subjected to a separate heat source that maintains the “cold” side at a lower temperature than the “hot” side. However, other configurations and arrangements may be provided to subject the separate sides of the thermo-electrochemical converter 10 to the appropriate temperature ranges for operation.

A first conduit 38 and a second conduit 40 may be provided in fluid communication with the first and third chambers 30, 34 so as to place the first and third chambers 30, 34 in fluid communication with one another to create a flow loop of the ionizable working fluid. A third conduit 42 may also be provided that is in fluid communication with the second and fourth chambers 32, 36 so as to place the second and fourth chambers 32, 36 in fluid communication with one another. In operation of the thermo-electrochemical converter 10, working fluid in the first chamber 30 is ionized at the first electrode of the first MEA 12, the ions proceed through the proton-exchange membrane 18 of the first MEA 12, and the working fluid is reconstituted at the second electrode 16 of the first MEA and contained within the second chamber 32. The working fluid passes to the fourth chamber 36 via the third conduit 42, where the working fluid is again ionized at the second electrode 26 of the second MEA 22. The ions proceed through the proton-exchange membrane 28 of the second MEA 22 and the working fluid is reconstituted at the first electrode 24 of the second MEA 22 and contained within the third chamber 34. The working fluid may then proceed back to the first chamber 30 via the first conduit 38. However, the working fluid in the first chamber 30 may also circulate back to the third chamber 34 in a loop via the second conduit 40, as described in further detail below.

In particular, a fluid handler 44 may be provided and configured to move the ionizable working fluid from the third chamber 34 to the first chamber 30 via the first conduit 38 as a way to efficiently apply the working fluid to the first electrode 14 of the first MEA 12. The fluid handler 44 may result in flow rates that are orders of magnitude higher than resulting mass flows from fluid evolution under absolute pressure operation, enabling an increase in the electrical output of the thermo-electrochemical converter 10. In some embodiments, the fluid handler 44 may be a pump, such as a diaphragm pump, a rotary vane pump, or other types of positive displacement pumps, or the like. In other embodiments, particularly where the working fluid is a gas, the fluid handler 44 may be a blower, such as a centrifugal blower, or the like.

To reduce mechanical stresses on the first MEA 12 and the proton-exchange membrane 18, the working fluid may be mixed with an inert carrier fluid in the first and third chambers 30, 34. The fluid handler 44 may help to minimize parasitic effects caused by concentration polarization from the carrier fluid blinding the first electrode 14 of the first MEA 12, and thereby improve overall performance. In the example embodiment where the working fluid is hydrogen (H₂) gas, the inert carrier fluid may be helium (He) gas. However, other inert carrier fluids may be used as well, depending on the nature of the ionizable working fluid and the constructions of the first and second MEAs 12, 22. The inert carrier fluid should not ionize at the first electrode 14 of the first MEA nor be able to ordinarily pass through the first MEA 12. The higher the density of the inert carrier fluid, the more any back diffusion through the proton-exchange membrane 18 of the first MEA 12 can be limited. For example, helium has a density of about 0.175 kg/m³ at STP, while argon has a density of about 1.78 kg/m³ at STP. Higher densities and corresponding molecular weights and atomic radii provide better resistance to back-diffusion through the proton-exchange membrane 18. In the embodiment shown, the first and third chambers 30, 34 include a mixture of about 1% H₂ gas and about 99% He gas (notably, the second and fourth chambers 32, 36 contain about 100% H₂ gas since the He gas will not ordinarily pass through the first MEA 12). However, other ratios may be used as well depending on, for example, flow rates generated by the fluid handler 44, the natures of the ionizable working fluid and the inert carrier fluid, the electrical output, the constructions of the MEAs 12, 22, and the like.

Higher fluid flow rates between the “hot” side and the “cold” side of the thermo-electrochemical converter 10 can lead to convective heat losses, particularly as the fluid handler 44 moves working fluid at approximately temperature T2 away from the third chamber 34 and into the first chamber 30, while working fluid from the first chamber 30 at approximately the lower temperature T1 is brought back into the third chamber 34 via the second conduit 40. The thermo-electrochemical converter 10 may therefore utilize a heat exchanger 46 that may be placed in thermal communication with the first and second conduits 38, 40. The heat exchanger 46 is configured to transfer heat from the working fluid (and carrier fluid, if present) in the first conduit 38 to the working fluid (and carrier fluid, if present) in the second conduit 40. That is heat from the working fluid coming from the third chamber 34 under the influence of the fluid handler 44 can heat the colder working fluid returning to the third chamber 34 via the second conduit 40. In this way, the working fluid entering the third chamber 34 is warmer than it otherwise would have been, helping to maintain the working fluid at the higher temperature at the second MEA 22. This also aids the first MEA 12, as the working fluid entering the first chamber 30 under the influence of the fluid handler 44 will not be as warm (having lost some heat via the heat exchanger 46 to working fluid heading in the other direction), thereby helping to maintain the working fluid in the first chamber 30 at its relatively lower temperature. The ultimate result is a finer temperature balance and maximization of the temperature difference between the hot and cold sides within the thermo-electrochemical converter 10.

The heat exchanger 46 may be of the shell-and-tube type. However, other heat exchanger types may be used as well, such as plate heat exchangers, finned tube heat exchangers, shell-and-coil heat exchangers, or the like. The heat exchanger 46 may utilize materials such as copper, aluminum, stainless steel, combinations thereof, or the like to facilitate optimal heat transfer efficiency. While a single heat exchanger 46 is shown in the accompanying drawing, additional heat exchangers (not shown) may be placed in thermal communication with the first and second conduits 38, 40 for additional temperature control, as desired. Moreover, while the pump 44 is shown located downstream of the heat exchanger 46 in the accompanying drawing, the pump 44 may alternatively be located upstream of the heat exchanger 46.

Example embodiments encompassed by the present disclosure further include methods of operating a thermo-electrochemical converter, such as the one shown in the accompanying drawing. An example of the method includes operating the first MEA 12, the first chamber 30 (containing the ionizable working fluid, potentially provided within the inert carrier fluid, at the first pressure), and the second chamber 32 (containing the ionizable working fluid at the second pressure greater than the first pressure) at the first temperature T1. The example method also includes operating the second MEA 22, the third chamber 34 (containing the ionizable working fluid, potentially provided within the inert carrier fluid, at the third pressure), and the fourth chamber 36 (containing the ionizable working fluid at the fourth pressure greater than the third pressure) at the second temperature T2. The first and second conduits 38, 40 are each provided in fluid communication with the first and third chambers 30, 34 and the third conduit 42 is provided in fluid communication with the second and fourth chambers 32, 36. The fluid handler 44 moves the ionizable working fluid (potentially along with the inert carrier fluid, when applicable) from the third chamber 34 to the first chamber 30 through the first conduit 38. The method additionally includes transferring the heat from the ionizable working fluid (and potentially the inert carrier fluid, when applicable) in the first conduit 38 to the ionizable working fluid (and potentially the inert carrier fluid, when applicable) in the second conduit 40 via the heat exchanger 46 in thermal communication with the first and second conduits 38, 40. Commensurate with the above description, additional and/or alternative steps may also be utilized.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

While specific and distinct embodiments have been shown in the drawings, various individual elements or combinations of elements from the different embodiments may be combined with one another while in keeping with the spirit and scope of the invention. Thus, an individual feature described herein only with respect to one embodiment should not be construed as being incompatible with other embodiments described herein or otherwise encompassed by the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined herein.

We claim:

1. A thermo-electrochemical converter comprising:
an ionizable working fluid;
a first membrane electrode assembly (MEA) and a second MEA electrically coupled to each other, each of the first and second MEAs comprising:
a first electrode permeable to the ionizable working fluid,
a second electrode permeable to the ionizable working fluid, and
a proton-exchange membrane sandwiched between the first and second electrodes;
a first chamber in fluid communication with the first electrode of the first MEA and containing the ionizable working fluid at a first pressure;
a second chamber in fluid communication with the second electrode of the first MEA and containing the ionizable working fluid at a second pressure greater than the first pressure, the first MEA, first chamber, and second chamber operating at a first temperature;
a third chamber in fluid communication with the first electrode of the second MEA and containing the ionizable working fluid at a third pressure;
a fourth chamber in fluid communication with the second electrode of the second MEA and containing the ionizable working fluid at a fourth pressure greater than the third pressure, the second MEA, third chamber, and fourth chamber operating at a second temperature greater than the first temperature;
a first conduit and a second conduit, each in fluid communication with the first chamber and the third chamber;
a third conduit in fluid communication with the second chamber and the fourth chamber;
a fluid handler configured to move the ionizable working fluid from the third chamber to the first chamber through the first conduit; and
a heat exchanger in thermal communication with the first and second conduits and configured to transfer heat from the ionizable working fluid in the first conduit to the ionizable working fluid in the second conduit.

2. The thermo-electrochemical converter of claim 1, wherein the ionizable working fluid is mixed with an inert carrier fluid in the first and third chambers.

3. The thermo-electrochemical converter of claim 2, wherein the working fluid is H₂ gas and the inert carrier fluid is He gas.

4. The thermo-electrochemical converter of claim 1, wherein the fluid handler is a pump.

5. The thermo-electrochemical converter of claim 4, wherein the pump is one of a diaphragm pump or a rotary vane pump.

6. The thermo-electrochemical converter of claim 1, wherein the fluid handler is a blower.

7. The thermo-electrochemical converter of claim 6, wherein the blower is a centrifugal blower.

8. The thermo-electrochemical converter of claim 1, wherein the heat exchanger is one of a shell-and-tube heat exchanger, a plate heat exchanger, a finned tube heat exchanger, or a shell-and-coil heat exchanger.

9. The thermo-electrochemical converter of claim 1, wherein the working fluid is H₂ gas.

10. A method of operating a thermo-electrochemical converter including an ionizable working fluid, and a first membrane electrode assembly (MEA) and a second MEA electrically coupled to each other, each of the first and second MEAs comprising: a first electrode permeable to the ionizable working fluid, a second electrode permeable to the ionizable working fluid, and a proton-exchange membrane sandwiched between the first and second electrodes, the method comprising:
operating, at a first temperature, the first MEA, a first chamber in fluid communication with the first electrode of the first MEA and containing the ionizable working fluid at a first pressure, and a second chamber in fluid communication with the second electrode of the first MEA and containing the ionizable working fluid at a second pressure greater than the first pressure;
operating, at a second temperature greater than the first temperature, the second MEA, a third chamber in fluid communication with the first electrode of the second MEA and containing the ionizable working fluid at a third pressure, and a fourth chamber in fluid communication with the second electrode of the second MEA and containing the ionizable working fluid at a fourth pressure greater than the third pressure;
providing a first conduit and a second conduit, each in fluid communication with the first chamber and the third chamber;
providing a third conduit in fluid communication with the second chamber and the fourth chamber;
moving, via a fluid handler, the ionizable working fluid from the third chamber to the first chamber through the first conduit; and
transferring heat from the ionizable working fluid in the first conduit to the ionizable working fluid in the second conduit via a heat exchanger in thermal communication with the first and second conduits.

11. The method of claim 10, further comprising providing the ionizable working fluid within an inert carrier fluid in the first and third chambers.

12. The method of claim 11, wherein the working fluid is H₂ gas and the inert carrier fluid is He gas.

13. The method of claim 10, wherein the working fluid is H₂ gas.
